(19) United States
(12) Patent Application Publication
(10) Pub. No.: US 2004/0047962 A1
(43) Pub. Date: Mar. 11, 2004

(54) Highly nutritious baked products

(76) Inventors: Akihisa Takaichi, Naruto-shi (JP); Toshihiko Okamoto, Tokushima-shi (JP); Yoshihide Azuma, Naruto-shi (JP); Katsumi Tamura, Itano-gun (JP); Hisashi Hagita, Itano-gun (JP); Izumi Hanya, Tokushima-shi (JP)

Correspondence Address: SUGHRUE MION, PLLC, 2100 PENNSYLVANIA AVENUE, N.W., WASHINGTON, DC, 20037, US

(21) Appl. No.: 10/451,880

(22) PCT Filed: Dec. 26, 2001
(86) PCT No.: PCT/JP01/11446

(30) Foreign Application Priority Data
Dec. 27, 2000 (JP) 2000-397513

(51) Int. Cl. A21D 10/00

(52) U.S. Cl. 426/549

(57) ABSTRACT

The present invention relates to a highly nutritious baked food product having ingredients similar to conventional baked food products but having a nutritionally balanced high protein content and low fat content, with an improved level of the hardness that conventionally results from a high protein content and low fat content. The highly nutritious baked food product can be produced by baking a dough containing 10-20 wt. % of protein, 7-14 wt. % of fat and 55-81 wt. % of sugar, with trehalose contained as a sugar component in 1 to 10 wt. % relative to the total weight of the solid ingredients.

### TECHNICAL FIELD

The present invention relates to a highly nutritious baked food product and a method for producing the same. More particularly, the invention relates to a snack-food-type, easy-to-eat, highly nutritious baked food product having a relatively high protein content and a crispy chewing texture that provides a crunchy eating sensation.

### BACKGROUND OF THE INVENTION

Dietary management and, particularly, nutritional management are very important aspects of health management. Skipping breakfasts and the irregular intake of lunches and suppers may lead not only to a lack of energy and nutritional supply necessary for daily activities but also to the hypofunction of the body due to a lethargic biorhythm. These poor eating habits burden organs and pose a risk of obesity, which is one of the primary causes of adult diseases, such as diabetes, hypertension, and cardiac diseases.

Various nutritious food products have been researched and developed for supplementing ordinary daily meals or for quickly restoring the energy that is used when playing sports or working. Many food products in liquid or solid form containing various nutrients are known today as nutritious food products.

Conventional nutritious food products, however, have a crucial shortcoming in that they contain an insufficient amount of protein. Moreover, several other problems are known to exist in these nutritious food products with respect to nutritional balance, digestibility and absorbability, nutritional value, etc.

The inventors earlier developed and marketed nutritious food products and the like in liquid form (see Japanese Examined Patent Publication No. 83653/1994) that are well balanced in nutrition with high protein and calorie content, thereby solving the aforementioned problems.

To further promote food products such as these that are well balanced in nutrition, the inventors started researching and developing a baked food product of this type, i.e., a highly nutritious food product. In the process, they have found the following: Heretofore known baked food products, for example, rice crackers (e.g., arare, senbei, etc.) and like rice confections; wafers, crackers, pies, biscuits, cookies, and like Western-type confections; and other snack-food products contain less than 10 wt. % of protein (see, for example, Ishiyaku Publishers, Inc. Japan Food Ingredients, 4^{th} Ed.; Chapter 4, Confectionery, Jan. 10, 1983; pp 61-66). When more than 10 wt. % of protein is provided in consideration of nutritional balance, the crispy or crunchy chewing texture (eating sensation, feeling in the mouth, etc.) of baked food products is generally impaired, and the baked food products exhibit disadvantages, such as a hard chewing texture and stickiness to the teeth. The chewing texture of baked food products is also affected by the fat content in addition to the protein content. The nutritious food products previously developed by the inventors could not exhibit the desired crispy chewing texture when the proportion of ingredients that were well balanced in nutrition, especially the protein and fat content thereof, was maintained.

### DISCLOSURE OF THE INVENTION

An object of the present invention is to provide a highly nutritious novel baked food product having ingredients improved in nutritional balance with a higher protein content and a lower fat content compared with known baked food products. Another object of the invention is to provide a highly nutritious baked food product having the crispy chewing texture of baked food products without the deterioration of chewing texture that is accompanied by modifying the ingredients.

The inventors conducted further research for the purposes described above, and, as a result, found the following surprising fact. That is, when trehalose, which is a sugar component, is used in a specified amount, the desired baked food product having an improved chewing texture that is crunchy and crispy and not sticky to the teeth can be obtained, thereby alleviating the previously-perceived deterioration of chewing texture (i.e., disadvantages such as becoming hard and sticky to the teeth) even when the ingredients thereof are nutritiously well balanced and contain a large amount of protein and a small amount of fat. The present invention was accomplished based on the above finding.

The present invention can be described as follows:

(1) A highly nutritious baked food product prepared by baking a dough containing 10 to 20 wt. % of protein, 7 to 14 wt. % of fat, and 55 to 81 wt. % of sugar, with trehalose being contained in the sugar in 1 to 10 wt. % relative to the total weight of solid ingredients.

(2) A highly nutritious baked food product as defined above, wherein the dough further contains 3 to 8.7 parts by weight of dietary fiber per 100 parts by weight of the total weight of the solid ingredients.

(3) A highly nutritious baked food product as defined above, wherein the content of protein is 12 to 18 wt. % relative to the total weight of the solid ingredients.

(4) A highly nutritious baked food product as defined above, wherein the content of fat is 8 to 11 wt. % relative to the total weight of the solid ingredients.

(5) A highly nutritious baked food product as defined above, wherein the content of sugar is 60 to 70 wt. % relative to the total weight of the solid ingredients.

(6) A highly nutritious baked food product as defined above, wherein the product is at least one member selected from the group consisting of crackers, biscuits, cookies, and wafers.

(7) A method for preparing a highly nutritious baked food product, the method comprising preparing a dough containing 10 to 20 wt. % of protein, 7 to 14 wt. % of fat, and 55 to 81 wt. % of sugar, with trehalose being contained in the sugar in 1-10 wt. % relative to the total weight of solid ingredients, and baking the dough.

The highly nutritious baked food product of the invention exhibits an excellent chewing texture, such as a crispy, light eating sensation and feeling in the mouth, with no stickiness to the teeth. Further, the baked food product is well balanced in nutrition by containing a relatively large amount of protein and a relatively small amount of fat. The highly nutritious baked food product of the invention is excellent in chewing texture as well as in nutritional balance so that the intake thereof can improve nutritionally unbalanced eating habits and can control the excessive calorie intake that can cause obesity, thereby effectively preventing and treating various diseases (preventing the aggravation thereof) caused by obesity, such as adult diseases including diabetes, hypertension, and cardiac diseases. The baked food product of the invention is also very useful as a diet food for healthy people. Specifically, healthy people can readily consume and enjoy the baked food product of the invention in the same manner as they consume and enjoy conventional baked food products, and the intake thereof poses no risk of causing obesity. The baked food product of the invention can effectively serve as breakfast, to provide vitality for the day. It is also suitable as a convenient dietary supplement for those who take meals irregularly, those who have a decreased appetite, those who cannot eat sufficiently, and others. Further, the baked food product of the invention can be used as a snack for growing children or as a refreshment for elderly people. In addition, it can be used as an energy supplement consumed after playing sports or used as an emergency food.

The highly nutritious baked food product of the invention and the method for producing it will be described below in detail.

The term “baked food product” herein refers to a food product prepared by suitably shaping a dough and baking it. Among baked food products, the present invention is directed more to those that exhibit a texture that provides a crispy, light eating sensation (crispiness). Examples of baked food products within the scope of the present invention include crackers, biscuits, cookies, wafers, etc.

Wafers are a baked food product prepared by baking a paste containing flour as the main ingredient, egg, and other ingredients. Crackers are a baked food product having relatively little sweetness but rich salt and fat content that are prepared by mixing flour, sugar, edible oil or fat, and salt as starting ingredients; adding to the mixture, as required, a dairy product, egg, yeast, enzymes, inflating agents, and the like; and shaping and baking the mixture. Biscuits and cookies are those prepared by shaping a dough containing flour, sugar, and edible fat or oil, as starting ingredients and, adding salt, a dairy product, egg, inflating agents, and the like as required, and baking the dough. Among these biscuits and cookies, those having a relatively low fat or oil content are called hard biscuits, those having a relatively high fat or oil content are called soft biscuits, and those having high fat or oil, and sugar contents are called cookies.

Proteins to be used in the baked food product of the present invention include a wide range of known vegetable or animal protein materials usually used in this field. Usually, those high vegetable protein materials containing protein in a proportion of about 70 wt. % or more (relative to the total solid weight), and preferably about 80 wt. % or more, are used alone or in combination with animal protein materials. Examples of proteins in high vegetable protein materials include soy bean protein, concentrated soy bean protein, wheat protein, corn gluten meal, soy bean protein isolate, and the like. The most preferable protein in high vegetable protein materials is soy bean protein isolate. High vegetable protein materials can be used alone or in a combination of two or more species. Animal protein materials containing protein in a proportion of 20 wt. % or more relative to the total solid weight can be advantageously used. Examples thereof include cow's milk, skim milk, and like dairy products; casein, albumin, globulin, and like milk proteins; and gelatin, whole egg, egg white, egg yolk, dried whole egg, and the like. Especially preferable proteins in animal protein materials are casein, albumin, globulin, and like milk proteins, and gelatin, egg white, and the like. Animal protein materials can also be used alone or in a combination of two or more species. Further, proteins in animal protein materials include microorganism-derived proteins.

Casein, which is one of the preferred proteins in animal protein materials, herein refers to casein sodium, casein calcium, and like casein salts, and the enzyme-hydrolyzed forms thereof. Accordingly, soy bean protein, wheat protein, and gelatin include the enzyme-hydrolyzed forms thereof. These enzyme-hydrolyzed forms are suitable as proteins for use in the present invention especially because they do not thermocoagulate. More specifically, the enzyme-hydrolyzed forms of the aforementioned proteins are preferably water-soluble proteins having the highest peak of molecular weight distribution in the range of 800 to 30,000, preferably 8,000 to 30,000, and more preferably 10,000 to 15,000. Specific examples are enzyme-hydrolyzed gelatin (water-soluble gelatin), enzyme-hydrolyzed casein, etc. The highest peak of molecular weight distribution of the enzyme-hydrolyzed proteins can be obtained from the molecular-weight distribution and concentration distribution measured by gel filtration and SDS-PAGE methods.

Fats to be used in the baked food product of the present invention include a wide range of known edible fats and oils that have heretofore been used in this field. They can be used alone or in a combination of two or more species. Examples include rice oil, cotton seed oil, corn oil, soy bean oil, olive oil, sunflower oil, cacao butter, sesame oil, safflower oil, peanut oil, coconut oil, nut oil, palm oil, rapeseed oil, and like vegetable oils; butter, lard, and like animal oils; and margarine, shortening, etc. Among these oils, vegetable oils are especially preferred.

Sugars to be used in the baked food product of the present invention include a wide range of known sugars that have heretofore been used in this field. Examples of sugars include glucose, lactose, fructose, and like monosaccharides; sucrose, granulated sugar, malt sugar, trehalose, maltose, isomaltose, and like disaccharides; maltotetraose, maltotriose, maltopentaose, maltohexaose, lacto-oligosaccharide, galactosyl lactose, lacto sucrose, and like oligosaccharides; glycogen, dextrin, starch (wheat starch and the like), and like polysaccharides; and the like. These sugars can be used alone or in a combination of two or more species.

It is especially important that the baked food product of the present invention contain a specific amount of trehalose as an ingredient of the sugar component. Through the use of trehalose, the baked food product of the invention can exhibit the desired chewing texture.

The protein, fat, and sugar described above are contained relative to the total weight of the solid ingredients (purity content) in a proportion selected from a range of 10 to 20 wt. % for the protein, 7 to 14 wt. % for the fat, and 55 to 81 wt. % for the sugar, and preferably 12 to 18 wt. % for the protein, 8 to 11 wt. % for the fat, and 60 to 70 wt. % for the sugar. The proportion of trehalose contained in the sugar is selected from a range of 1 to 10 wt. %, and preferably 2 to 4 wt. % relative to the total weight of the solid ingredients.

The inventors have accomplished the present invention based on the finding that by using the ingredients in the proportions specified above, the desired baked food product can be obtained, which is well balanced in nutrition and exhibits an improved chewing texture. Specifically, even when protein, fat, and sugar are used in the specified proportions to obtain a baked food product with well-balanced nutrition, if trehalose is not contained in the sugar or if trehalose is contained in a proportion below the specified range, the baked food product thus obtained is unsatisfactory in that the intrinsic crispy chewing texture of the baked food product is impaired. On the contrary, when trehalose is contained in the proportion specified above, the resulting baked food product is well balanced in nutrition and any reduction in the chewing texture that might otherwise result from adjusting the nutritional balance is prevented, thereby enabling the desired baked food product of the present invention, with an excellent chewing texture, to be achieved.

For the baked food product of the present invention, a suitable amount of dietary fiber (for example, indigestible starches obtained by subjecting polydextrose, high amylose cornstarch, or the like to moist heat treatment; pectic acid and the salt thereof; alginic acid and the salt thereof; and the like) can be added to the dough containing the starting ingredients. Usually, the amount of dietary fiber used is selected from the range of 3 to 8.7 wt. % per 100 wt. % of the total solid weight. It is beneficial to ingest the baked food product of the invention thus prepared since it can also supply dietary fibers. According to Recommended Dietary Allowances for the Japanese, 6th revision (edited by the Ministry of Health and Welfare, Pharmaceutical Safety Bureau), the daily dietary fiber intake recommended for Japanese is 10 g/1,000 Kcal. The ingestion of the baked food product of the invention can satisfy this recommended amount. Therefore, the ingestion of the baked food product of the invention containing dietary fiber is also advantageous in lowering the risk of colon cancer caused by an insufficient intake of dietary fiber.

Various additives that are generally used in the field of food production can be added to the baked food product of the invention as necessary to increase the nutritional value, to impart flavor and aroma, and to provide color. Examples of additives to fortify the nutritional value of the baked food product of the invention include a variety of vitamins (vitamin A, vitamin B₁, vitamin B₂, vitamin B₆, vitamin B₁₂, vitamin C, vitamin D, vitamin E, niacin, folic acid, pantothenic acid, etc.), minerals (calcium salt, iron salt, potassium salt, sodium salt, magnesium salt, phosphate, chloride, etc), and the like. Examples of additives to impart flavor and aroma include flavorings (synthetic and natural flavorings), natural sweeteners (saumatin, stevia, etc.), synthetic sweeteners (saccharin, sucralose, aspartame, etc.), soy sauce, miso, chemical seasonings, flavor enhancers (cheese, chocolate, etc.), and the like. Examples of additives to provide color include caramel and like natural colorants, etc. Moreover, the additives described above include various emulsifiers (sucrose fatty acid esters, lecithin, glycerin fatty acid esters, polyglycerin fatty acid esters, etc.), stabilizers, and antiseptic agents that are widely used in the field of food production. These additives can be used alone or in a combination of two or more species. The use (addition, incorporation) of vitamins, minerals, etc., is especially preferable. These additives are preferably used in a proportion up to about 3 parts by weight per 100 parts by weight of the total solid weight. Other additives are used in a proportion that is usually selected for the additives. However, each additive belonging to its respective group is usually used in a proportion selected from a range not exceeding about 2 parts by weight per 100 parts by weight of the total solid weight. And, all additives generally comprise not more than about 10 parts by weight of 100 parts by weight of the total solid weight. Insofar as the proportions of the additives are within the ranges specified above, the crispy chewing texture of the baked food product of the invention is not impaired.

Further, table salt, yeast, enzymes, inflating agents, and the like may be added to the baked food product of the invention according to the type of baked food product to be prepared. Examples of enzymes include a variety of proteases, amylases, cellases, and the like that are generally known in the field of food production. Examples of inflating agent include sodium hydrogen carbonate, ammonium hydrogen carbonate, etc., and those containing sodium hydrogen carbonate, ammonium hydrogen carbonate, or the like that are widely used in the food industry. A typical example is commercially available baking powder. Table salt, yeast, enzymes, and inflating agents can be used in an amount usually selected for a baked food product. Generally, the amount of each of these additives comprises not more than about 1 wt. % of 100 parts by weight of the total solid weight, and the total amount of these additives comprises not more than about 2 parts by weight of 100 parts by weight of the total solid weight. The use of these additives does not adversely affect the crispy chewing texture of the baked food product of the present invention.

In the method for preparing the baked food product of the invention, a dough containing the aforementioned ingredients is prepared first. This dough can be prepared by blending the specified amount of the ingredients with water and kneading the mixture.

The amount of water used relative to the ingredients (protein, fat, sugar, dietary fiber, additive, etc.) can be suitably selected according to the type of baked food product to be prepared, provided that the dough prepared by blending these ingredients can be shaped and baked into the intended baked food product. It is usually selected from a range not exceeding about 2.4 times the total weight of the solid ingredients. For example, when the baked food product is a biscuit or a cookie, water may be used in an amount selected from about 0 to about 30 parts by weight (about 0 to about 16.7 wt. % of the total weight), and preferably about 0 to about 25 parts by weight (about 0 to about 20 wt. % of the total weight) per 100 parts by weight of the total weight of the solid ingredients. When the baked food product is a cracker, water may be used in an amount selected from 25 to 45 parts by weight (about 20 to about 31 wt. % of the total weight), and preferably about 30 to about 40 parts by weight (about 23 to about 28.5 wt. % of the total weight) per 100 parts by weight of the total weight of the solid ingredients. When the baked food product is a wafer, water may be used in an amount selected from about 2.0 to about 2.4 parts by weight, and preferably about 2.1 to about 2.3 parts by weight relative to the total weight of the solid ingredients.

A dough can be prepared by blending and kneading the ingredients employing machines and conditions that are generally employed in production of this kind. Blending and kneading are preferably conducted to yield a uniform dough. Specifically, for example, each ingredient in powder form is measured first, and they are mixed. Water and animal protein materials with a high liquid content (e.g., cow's milk, whole egg, etc.) are then added to the mixture. The water and protein materials with a high liquid content can be preheated to about 50° C. and added to the mixture. When the preheated water and protein materials with a high liquid content are used, the temperature of the resulting dough will be increased to about 30 to about 35° C., which will make it softer than dough prepared at room temperature. Such soft dough offers an advantage of making the subsequent shaping procedure easier.

In the present invention, the dough obtained above is shaped or molded into a desired form. Shaping or molding can be conducted according to a known method using a depositor, draw roller, etc. The shape can be suitably selected. Usually, for easier production and easier eating of the food product, the dough is preferably shaped into a sheet form having a thickness of about 0.5 to about 5 mm, a stick form having a diameter of about 1.0 to about 10.0 mm, or another form. The size or length for the molded dough can be suitably selected considering the ease of eating, handling, etc. A dough that has once been shaped or molded or a final shaped dough can also be further trimmed into the desired size.

Baking (roasting) the shaped dough prepared above is an essential process in the present invention. Baking enables to obtain the desired baked food product of the invention. Specifically, baking enables a baked food product that has the desired crispiness, i.e., crunchy and light eating sensation, that is excellent in texture such as palatability and feeling in the mouth, and that contains a large amount of highly absorbable protein to be obtained.

The baking conditions can be suitably selected according to the kind of ingredients used, the liquid content of the dough, etc. These condition employed herein are not different from the conditions generally employed in ordinary baked food production. Although baking conditions vary according to the type of baked food product desired, baking temperatures are usually selected from a range of about 60 to about 250° C., and baking times are selected from a range of about 2 to about 60 minutes. Especially preferable baking temperatures and baking times are usually selected from a range of about 160 to about 220° C. and a range of about 8 to about 15 minutes, respectively.

Heat sources for the baking are not limited, and a variety of heat sources can be used. Specifically, examples include those employing combustion heat, such as hot water, steam, electric heaters, gas ovens, etc., and those employing microwaves, far-infrared rays, infrared rays, etc., such as a microwave oven and the like.

By preparing a dough having the specific components described above and then baking it, the resulting baked food product of the present invention can provide an enhanced protein flavor, prevent a powdery texture, and acquire a confection-like flavor and crispy chewing texture, thereby enabling the baked food product to exhibit excellent characteristics such as an excellent texture, i.e., an excellent eating sensation and feeling in the mouth with no stickiness to the teeth, and excellent digestibility and absorbability, without the undesirable thermal degeneration of protein, hard chewing texture, decreased nutritional values caused by protein decomposition, and loss of nutritional balance.

Since the baked food product of the invention has a high protein content and good nutritional balance in addition to the excellent eating texture described above, it can be eaten as a health food by ordinary families, and enjoyed in its original form as a snack food in place of the conventional baked food products of this type. Further, it is suitable as a food product to be consumed when building and strengthening muscles for the purpose of enhancing one's physical condition through sports, body building, weight training, aerobics, jogging, etc.

### BEST MODE FOR CARRYING OUT THE INVENTION

Examples are given below to illustrate the present invention in more detail. The term “parts” and the symbol “%” refer respectively to “parts by weight” and “weight %” unless specified otherwise.

### EXAMPLE 1

### Preparation of Hard Biscuits

A dough was prepared by mixing, in the amounts specified, the ingredients shown in Table 1 below except for water, then adding water to the mixture, and blending the mixture for four minutes using a mixer (Type: N-50, product of Hobart Corp.) at low speed.

TABLE 1

| Ingredients | | |
|---|---|---|
| Wheat flour | 45 | g |
| Animal protein | 6 | g |
| Vegetable protein | 2 | g |
| Margarine | 6 | g |
| Wheat starch | 6 | g |
| Inflating agent | 0.7 | g |
| Vitamins and minerals | Appropriate amount | |
| Emulsifier | Appropriate amount | |
| Water | 23 | g |
| Trehalose | 5 | g |
| Granulated sugar | 5 | g |
| Total amount | 100 | g |
| Water content (%) | 1.5 | |
| Protein content (%) | 14 | |
| Fat content (%) | 9 | |
| Sugar content (%) | 72 | |
| Dietary fiber content (%) | 1.5 | |
| Ash content (%) | 1.2 | |

Soft flour (protein content: 8%, sugar content: 73.5%, and dietary fiber content: 2.5%) was used as wheat flower. Powdered skim milk (protein content: 34%) was used as an animal protein. Soybean protein isolate powder (protein content: 80%) was used as a vegetable protein. Margarine contained fat in a proportion of about 82%. Baking powder (commercial item) was used as an inflating agent. Vitamin B₁, vitamin B₂, vitamin B₆, vitamin B₁₂, vitamin C, nicotinic-acid amide, calcium pantothenate, and calcium carbonate were used as vitamins and minerals.

The water, protein, fat, sugar, dietary fiber, and ash content of the dough obtained above was measured according to the method described below. Results are also shown in Table 1.

### Measurement Method

Water content: weight loss upon drying (105° C., 3 hours)

Protein content: crude protein determination (Kjeldahl method)

Fat content: crude fat determination (ether extraction process)

Ash content: measurement of residues left after removing organic matter and water by heating at 550° C.

Sugar content: calculated by subtracting the sum of water, protein, fat, dietary fiber, and ash content from the total amount

Dietary fiber content: Prosky method (enzyme-weight method:

AOAC (Association of Official Analytical Chemists))

The dough was pressed into a sheet form having dimensions of about 300 mm× about 500 mm×2 mm (thickness) by a sheet roller, cut into rectangular pieces having dimensions of 10 mm×120 mm, and baked in a gas oven at a temperature of 180 to 210° C. for 8 to 15 minutes to yield the samples (hard biscuits) of the baked food product of the invention.

### EXAMPLE 2

### Preparation of Hard Biscuits

A dough was prepared by mixing, in the amounts specified, the ingredients shown in Table 2 below except for water, then adding water to the mixture, and blending the mixture for 4 minutes using a mixer (Type: N-50, product of Hobart Corp.) at low speed.

Wheat flour, animal protein, vegetable protein, margarine, wheat starch, inflating agent, vitamins and minerals, and emulsifier are those as used in Example 1. High amylose cornstarch was moist heat treated and used as an indigestible starch (dietary fiber content: about 60%).

The water, protein, fat, sugar, dietary fiber, and ash content of the dough thus prepared was measured in the same manner as in Example 1. Table 2 also shows the results.

TABLE 2

| Ingredients | | |
|---|---|---|
| Wheat flour | 45 | g |
| Animal protein | 6 | g |
| Vegetable protein | 2 | g |
| Margarine | 6 | g |
| Indigestible starch | 6 | g |
| Inflating agent | 0.7 | g |
| Vitamins and minerals | Appropriate amount | |
| Emulsifier | Appropriate amount | |
| Water | 23 | g |
| Trehalose | 5 | g |
| Granulated sugar | 5 | g |
| Total amount | 100 | g |
| Water content (%) | 1.5 | |
| Protein content (%) | 14 | |
| Fat content (%) | 9 | |
| Sugar content (%) | 67 | |
| Dietary fiber content (%) | 6.5 | |
| Ash content (%) | 2 | |

The dough was pressed into a sheet form having dimensions of about 300 mm× about 500 mm×2 mm (thickness) by a sheet roller, cut into rectangular pieces having dimensions of 10 mm×120 mm, and baked in a gas oven at a temperature of 180 to 210° C. for 8 to 15 minutes to yield the samples (hard biscuits) of the baked food product of the present invention.

### EXAMPLE 3

### Preparation of Hard Biscuits

A dough was prepared in the same manner and using the same ingredients as in Example 2 except that granulated sugar was not used at all and trehalose was used in an amount of 10 g. The dough was shaped and baked in the same manner as in Example 2 to yield the samples (hard biscuits) of the baked food product of the invention.

The water, protein, fat, sugar, dietary fiber, and ash content of the dough obtained above was measured in the same manner as in Example 1. The results were substantially identical to those obtained in Example 2.

### COMPARATIVE EXAMPLE 1

### Preparation of Hard Biscuits

A dough was prepared in the same manner and using the same ingredients as in Example 2 except that trehalose was not used at all and granulated sugar was used in an amount of 10 g. The dough was shaped and baked in the same manner as in Example 2 to yield the comparative samples of the baked food product.

The water, protein, fat, sugar, dietary fiber, and ash content of the dough obtained above measured in the same manner as in Example 1 was substantially identical to those obtained in Example 2.

### TEST EXAMPLE 1

### Sensory Analysis of Chewing Texture

A sensory test (panel test) was conducted for the samples of the baked food product prepared in Example 2 and Comparative Example 1 as described below. Specifically, the chewing texture of the samples of the food product of the present invention was evaluated as follows: Ten adult males and ten adult females (total: 20 adults) were randomly selected as panelists, and allowed to eat the samples at will. The comparative samples of the baked food product obtained in Comparative Example 1 were used as a control, and the number of panelists who answered that the samples prepared in Example 2 (1) have a better feeling in the mouth, (2) are crispier, and (3) are less sticky to the teeth were counted.

As a result, 15 out of 20 panelists (75%) answered that the samples prepared in Example 2 had a better feeling in the mouth (1); 16 out of 20 panelists (80%) answered that the samples prepared in Example 2 were crispier (2); and 13 out of 20 panelists (65%) answered that the samples prepared in Example 2 were less sticky to the teeth (3).

The sensory test verified that the samples of the baked food product of the present invention have an excellent chewing texture.

### TEST EXAMPLE 2

### Property (hardness) Analysis

Each sample prepared in Examples 2 and 3 and Comparative Example 1 was placed on the sampling table of a texture analyzer (manufactured by Stable Micro Systems, Inc.). A load was applied to the center of the samples vertical to their longer side at a rate of 0.5 mm/sec by a blade probe (blade portion: 70 mm×90 mm×3 mm (thickness), Blade Set with Knife HDP/BSK, manufactured by Stable Micro Systems, Inc.) and was measured when the samples broke. The breaking strength was used as an indicator for hardness (higher values indicate greater hardness). Table 3 shows the results.

TABLE 3

| Samples | Ex. 2 | Ex. 3 | Comp. Ex. 1 |
|---|---|---|---|
| Breaking strength (g) | 254 | 250 | 285 |

Based on the results shown in Table 3, it was found that the samples prepared in Comparative Example 1, which contain no trehalose, have a breaking strength of 285 g and thus are hard, while the samples of the baked food product of the present invention, due to the trehalose content, have breaking strengths of 254 g (Example 2) and 250 g (Example 3) and thus are very soft.

### EXAMPLES 4 AND 5

### Preparation of Hhard Biscuits

Samples (hard biscuits) of the baked food product of the present invention were prepared in the same manner as in Example 1 except that the amount of margarine (6 g in Example 1) was changed to 8.5 g in Example 4 and to 10 g in Example 5.

The biscuit samples thus obtained had an excellent crispy chewing texture identical to that of the samples prepared in Example 1.

### EXAMPLES 6 AND 7

### Preparation of Hard Biscuits

Samples (hard biscuits) of the baked food product of the present invention were prepared in the same manner as in Example 2 except that the amount of margarine (6 g in Example 2) was changed to 8.5 g in Example 6 and to 10 g in Example 7.

The biscuit samples thus obtained had an excellent crispy chewing texture identical to that of the samples prepared in Example 2.

### EXAMPLE 8

### Preparation of Hard Biscuits

Samples (hard biscuits) of the baked food product of the present invention were prepared in the same manner as in Example 1 except that the amount of wheat flour (45 g in Example 1) was changed to 39 g, the amount of animal protein (6 g in Example 1) was changed to 11 g, and the amount of vegetable protein (2 g in Example 1) was changed to 3 g.

The biscuit samples thus obtained had an excellent crispy chewing texture identical to that of the samples prepared in Example 1.

### EXAMPLE 9

### Preparation of Hard Biscuits

Samples (hard biscuits) of the baked food product of the present invention were prepared in the same manner as in Example 2 except that the amount of wheat flour (45 g in Example 1) was changed to 39 g, the amount of animal protein (6 g in Example 1) was changed to 11 g, and the amount of vegetable protein (2 g in Example 1) was changed to 3 g.

The biscuit samples thus obtained had an excellent crispy chewing texture identical to that of the samples prepared in Example 2.

### EXAMPLE 10

### Preparation of Wafers

A dough was prepared in the same manner as in Example 1 using the specific amount of the ingredients shown in Table 4. After shaping, the dough was baked in a gas oven at a temperature of 190 to 195° C. for about two minutes, thereby yielding the highly nutritious baked food product (wafers) of the present invention.

The water, protein, fat, sugar, dietary fiber, and ash content of the dough thus prepared was measured in the same manner as in Example 1. Table 4 also shows the results.

TABLE 4

| Ingredients | | |
|---|---|---|
| Wheat flour (high protein flour) | 12.5 | g |
| Wheat flour (medium-strength flour) | 12.5 | g |
| Corn starch | 2.4 | g |
| Table salt | 0.1 | g |
| Sodium bicarbonate | 0.5 | g |
| Soy bean lecithin | 0.5 | g |
| Corn oil | 0.5 | g |
| Water | 70 | g |
| Trehalose | 1 | g |
| Total solid content | 26% | |
| Protein content (%) | 10 | |
| Fat content (%) | 5.6 | |
| Sugar content (%) | 80.6 | |
| Dietary fiber content (%) | 2.6 | |
| Ash content (%) | 1.2 | |

The protein content of the wheat flour (high protein flour) was about 11.7% and that of the wheat flour (medium-strength flour) was about 9%.

The highly nutritious baked food product (wafers) of the invention thus prepared had the desired crunchy, crispy chewing texture.

### EXAMPLE 11

### Preparation of Crackers

A dough was prepared using the specific amount of the ingredients shown in Table 5 in the same manner as in Example 1. After shaping, the dough was baked in a gas oven at a temperature of 245° C. for about five minutes, thereby yielding the baked food product (crackers) of the present invention.

The water, protein, fat, sugar, dietary fiber, and ash content of the dough thus prepared was measured in the same manner as in Example 1. Table 5 also shows the results.

TABLE 5

| Ingredients | | |
|---|---|---|
| Wheat flour (high protein flour) | 66.6 | g |
| Dried yeast | 0.6 | g |
| Table salt | 0.8 | g |
| Shortening | 5.7 | g |
| Yeast food | 0.1 | g |
| Sodium bicarbonate | 0.1 | g |
| Water | 24.6 | g |
| Trehalose | 1.5 | g |
| Total solid content | 66% | |
| Protein content (%) | 11.8 | |
| Fat content (%) | 10.4 | |
| Sugar content (%) | 73.5 | |
| Dietary fiber content (%) | 2.7 | |
| Ash content (%) | 1.6 | |

The highly nutritious baked food product (crackers) of the invention thus prepared had the desired crunchy, crispy chewing texture.

1. A highly nutritious baked food product prepared by baking a dough containing 10 to 20 wt. % of protein, 7 to 14 wt. % of fat, and 55 to 81 wt. % of sugar, with trehalose being contained in the sugar in 1 to 10 wt. % relative to the total weight of solid ingredients.

2. A highly nutritious baked food product according to claim 1, wherein the dough further contains 3 to 8.7 parts by weight of dietary fiber per 100 parts by weight of the total weight of the solid ingredients.

3. A highly nutritious baked food product according to claim 1, wherein the content of protein is 12 to 18 wt. % relative to the total weight of the solid ingredients.

4. A highly nutritious baked food product according to claim 1, wherein the content of fat is 8 to 11 wt. % relative to the total weight of the solid ingredients.

5. A highly nutritious baked food product according to claim 1, wherein the content of sugar is 60 to 70 wt. % relative to the total weight of the solid ingredients.

6. A highly nutritious baked food product according to claim 1, wherein the product is at least one member selected from the group consisting of crackers, biscuits, cookies, and wafers.

7. A method for producing a highly nutritious baked food product, the method comprising preparing a dough containing 10 to 20 wt. % of protein, 7 to 14 wt. % of fat, and 55 to 81 wt. % of sugar, with trehalose being contained in the sugar in 1 to 10 wt. % relative to the total weight of solid ingredients, and baking the dough.
